(19) United States
(12) Patent Application Publication
(10) Pub. No.: US 2026/0312972 A1
(43) Pub. Date: Oct. 8, 2026

(54) MULTIMODAL MACHINE LEARNING-BASED ANOMALY DETECTION

(71) Applicant: Dell Products L.P., Round Rock, TX (US)

(72) Inventors: Zijia Wang, London (GB); Mustafa AlBado, Cork (IE); Thuy Truong, Ovens (IE)

(21) Appl. No.: 19/172,762

(22) Filed: Apr. 8, 2025

(51) Int. Cl. H04L 9/40

(52) U.S. Cl. CPC H04L 63/1425; H04L 63/1441

(57) ABSTRACT

An apparatus comprises at least one processing device configured to determine information characterizing operation of information technology assets in an information technology infrastructure environment, the determined information comprising two or more different data modalities. The at least one processing device is also configured to process the determined information utilizing data modality-specific machine learning encoders to generate encoded features for each of the different data modalities, to determine scaling coefficients for the different data modalities, and to generate a combined representation of the encoded features generated for the different data modalities utilizing the determined scaling coefficients. The at least one processing device is further configured to process, utilizing a multimodal machine learning model, the combined representation to detect anomalies in the operation of the information technology assets, and to modify operation of the information technology assets in response to detecting the anomalies.

### BACKGROUND

As the value and use of information continues to increase, individuals and businesses seek additional ways to process and store information. Information processing systems may be used to process, compile, store and communicate various types of information, including through the use of artificial intelligence and machine learning. Multimodal machine learning is a type of deep learning in which multiple different types of data, referred to as data modalities, are combined and processed simultaneously.

### SUMMARY

Illustrative embodiments of the present disclosure provide techniques for multimodal machine learning-based anomaly detection.

In one embodiment, an apparatus comprises at least one processing device comprising a processor coupled to a memory. The at least one processing device is configured to determine information characterizing operation of information technology assets in an information technology infrastructure environment, the determined information comprising two or more different data modalities. The at least one processing device is also configured to process the determined information utilizing two or more data modality-specific machine learning encoders to generate encoded features for each of the two or more different data modalities, to determine, based at least in part on performance indicators for the two or more different data modalities, scaling coefficients for the two or more different data modalities, and to generate, utilizing the determined scaling coefficients, a combined representation of the encoded features generated for each of the two or more different data modalities. The at least one processing device is further configured to process, utilizing a multimodal machine learning model, the combined representation of the encoded features generated for each of the two or more different data modalities to detect one or more anomalies in the operation of the information technology assets in the information technology infrastructure environment, and to modify operation of the information technology assets in the information technology infrastructure environment in response to detecting the one or more anomalies.

These and other illustrative embodiments include, without limitation, methods, apparatus, networks, systems and processor-readable storage media.

### BRIEF DESCRIPTION OF THE DRAWINGS

FIG. 1 is a block diagram of an information processing system configured for multimodal machine learning-based anomaly detection in an illustrative embodiment.

FIG. 2 is a flow diagram of an exemplary process for multimodal machine learning-based anomaly detection in an illustrative embodiment.

FIG. 3 shows a system configured for multimodal machine learning-based threat detection in an illustrative embodiment.

FIG. 4 shows temporal gradient decomposition in an illustrative embodiment.

FIG. 5 shows a process flow for multimodal machine learning-based threat detection in an illustrative embodiment.

FIG. 6 shows a plot of training convergence for different multimodal machine learning models in an illustrative embodiment.

FIG. 7 shows a table of evaluation metrics for different multimodal machine learning models in an illustrative embodiment.

FIGS. 8 and 9 show examples of processing platforms that may be utilized to implement at least a portion of an information processing system in illustrative embodiments.

### DETAILED DESCRIPTION

Illustrative embodiments will be described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center or other type of cloud-based system that includes one or more clouds hosting tenants that access cloud resources.

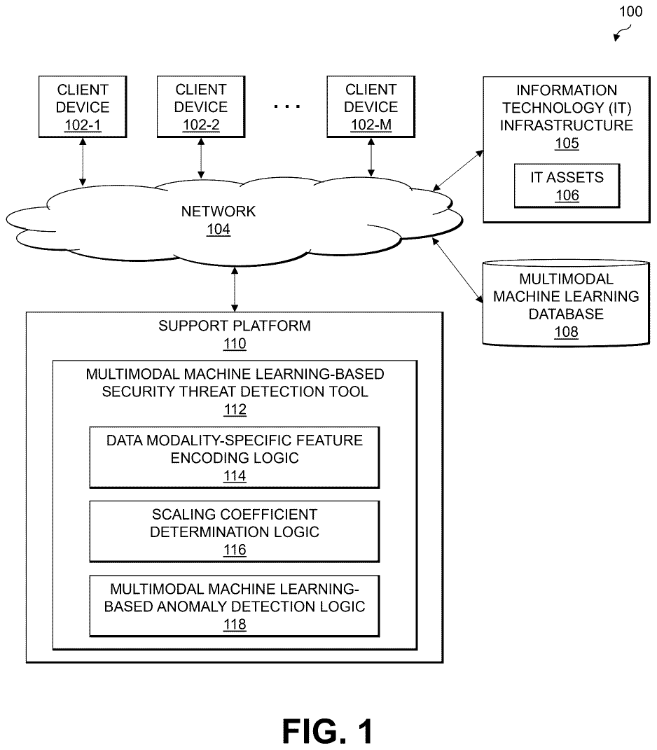

FIG. 1 shows an information processing system 100 configured in accordance with an illustrative embodiment. The information processing system 100 is assumed to be built on at least one processing platform and provides functionality for multimodal machine learning-based anomaly detection. The information processing system 100 includes a set of client devices 102-1, 102-2, . . . 102-M (collectively, client devices 102) which are coupled to a network 104. Also coupled to the network 104 is an information technology (IT) infrastructure 105 comprising one or more IT assets 106, a multimodal machine learning database 108, and a support platform 110. The IT assets 106 may comprise physical and/or virtual computing resources in the IT infrastructure 105. Physical computing resources may include physical hardware such as servers, storage systems, networking equipment, Internet of Things (IoT) devices, other types of processing and computing devices including desktops, laptops, tablets, smartphones, etc. Virtual computing resources may include virtual machines (VMs), containers, etc.

In some embodiments, the support platform 110 is used for an enterprise system. For example, an enterprise may subscribe to or otherwise utilize the support platform 110 for monitoring of security threats associated with an IT infrastructure environment that is operated by or managed by the enterprise (e.g., the IT infrastructure 105). As used herein, the term “enterprise system” is intended to be construed broadly to include any group of systems or other computing devices. For example, the IT assets 106 of the IT infrastructure 105 may provide a portion of one or more enterprise systems. A given enterprise system may also or alternatively include one or more of the client devices 102. In some embodiments, an enterprise system includes one or more data centers, cloud infrastructure comprising one or more clouds, etc. A given enterprise system, such as cloud infrastructure, may host assets that are associated with multiple enterprises (e.g., two or more different businesses, organizations or other entities).

The client devices 102 may comprise, for example, physical computing devices such as IoT devices, mobile telephones, laptop computers, tablet computers, desktop computers or other types of devices utilized by members of an enterprise, in any combination. Such devices are examples of what are more generally referred to herein as “processing devices.” Some of these processing devices are also generally referred to herein as “computers.” The client devices 102 may also or alternately comprise virtualized computing resources, such as VMs, containers, etc.

The client devices 102 in some embodiments comprise respective computers associated with a particular company, organization or other enterprise. Thus, the client devices 102 may be considered examples of assets of an enterprise system. In addition, at least portions of the information processing system 100 may also be referred to herein as collectively comprising one or more “enterprises.” Numerous other operating scenarios involving a wide variety of different types and arrangements of processing nodes are possible, as will be appreciated by those skilled in the art.

The network 104 is assumed to comprise a global computer network such as the Internet, although other types of networks can be part of the network 104, including a wide area network (WAN), a local area network (LAN), a satellite network, a telephone or cable network, a cellular network, a wireless network such as a WiFi or WiMAX network, or various portions or combinations of these and other types of networks.

The multimodal machine learning database 108 is configured to store and record various information that is utilized by the support platform 110 for performing multimodal machine learning for security threat detection (e.g., for detecting security threats associated with the IT assets 106 of the IT infrastructure 105, with the client devices 102 that access or otherwise utilize the IT assets 106 of the IT infrastructure 105, etc.). Such information may include, for example, different data modalities used in multimodal machine learning, including network logs, user behaviors and system events associated with the client devices 102 and/or the IT assets 106 of the IT infrastructure 105. Such information may also or alternatively include encoder models for different data modalities, training data, performance indicators for different data modalities, scaling coefficients, hyperparameters, local and aggregated gradients, weights and scaling factors, stochastic noise components, etc. The multimodal machine learning database 108 may be implemented utilizing one or more storage systems. The term “storage system” as used herein is intended to be broadly construed. A given storage system, as the term is broadly used herein, can comprise, for example, content addressable storage, flash-based storage, network-attached storage (NAS), storage area networks (SANs), direct-attached storage (DAS) and distributed DAS, as well as combinations of these and other storage types, including software-defined storage. Other particular types of storage products that can be used in implementing storage systems in illustrative embodiments include all-flash and hybrid flash storage arrays, software-defined storage products, cloud storage products, object-based storage products, and scale-out NAS clusters. Combinations of multiple ones of these and other storage products can also be used in implementing a given storage system in an illustrative embodiment.

Although not explicitly shown in FIG. 1, one or more input-output devices such as keyboards, displays or other types of input-output devices may be used to support one or more user interfaces to the support platform 110, as well as to support communication between the support platform 110 and other related systems and devices not explicitly shown.

The support platform 110 may be provided as a cloud service that is accessible by one or more of the client devices 102 to allow users thereof to perform management and monitoring of the IT assets 106 of the IT infrastructure 105 for an enterprise, organization or other entity. In some embodiments, the client devices 102 are utilized by members of the same enterprise, organization or other entity that operates the support platform 110. In other embodiments, the client devices 102 are utilized by members of one or more enterprises, organizations or other entities different than the enterprise, organization or other entity that operates the support platform 110 (e.g., a first enterprise provides support functionality for multiple different customers, businesses, etc.). Various other examples are possible.

In some embodiments, the client devices 102 and/or the IT assets 106 of the IT infrastructure 105 may implement host agents that are configured for automated transmission of information with the multimodal machine learning database 108 and the support platform 110 (e.g., network logs, user behaviors, system events, etc. associated with the IT assets 106, security threats detected by the support platform 110, remedial actions or instructions for addressed detected security threats including commands to perform automated modifications to the configurations of the IT assets 106 and/or the client devices 102 which access the IT assets 106). It should be noted that a “host agent” as this term is generally used herein may comprise an automated entity, such as a software entity running on a processing device. Accordingly, a host agent need not be a human entity.

The support platform 110 in the FIG. 1 embodiment is assumed to be implemented using at least one processing device. Each such processing device generally comprises at least one processor and an associated memory, and implements one or more functional modules or logic for controlling certain features of the support platform 110. In the FIG. 1 embodiment, the support platform 110 implements a multimodal machine learning-based security threat detection tool 112. The multimodal machine learning-based security threat detection tool 112 comprises data modality-specific feature encoding logic 114, scaling coefficient determination logic 116, and multimodal machine learning-based anomaly detection logic 118. The multimodal machine learning-based security threat detection tool 112 is configured to obtain information (e.g., from IT assets 106 of the IT infrastructure 105, from client devices 102, from multimodal machine learning database 108) characterizing operation of the IT assets 106 of the IT infrastructure 105, where the obtained information includes multiple data modalities. The data modality-specific feature encoding logic 114 is configured to process the obtained information utilizing data modality-specific machine learning encoders to generate encoded features for each of the different data modalities. The scaling coefficient determination logic 116 is configured to determine, based at least in part on performance indicators for the different data modalities, scaling coefficients for the different data modalities, and to generate, utilizing the determined scaling coefficients, a combined representation of the encoded features generated for the different data modalities. The multimodal machine learning-based anomaly detection logic 118 is configured to process the combined representation of the encoded features generated for the different data modalities utilizing a multimodal machine learning model to detect anomalies in the operation of the IT assets 106 of the IT infrastructure 105. The multimodal machine learning-based security threat detection tool 112 is configured to modify operation of the IT assets 106 in the IT infrastructure 105 in response to detecting the anomalies. This may include, for example, blocking or otherwise modifying access to ones of the IT assets 106 in the IT infrastructure 105, applying security patches or other fixes or updates to the IT assets 106 in the IT infrastructure, blocking or otherwise controlling network traffic in the IT infrastructure 105, etc.

At least portions of the multimodal machine learning-based security threat detection tool 112, the data modality-specific feature encoding logic 114, the scaling coefficient determination logic 116, and the multimodal machine learning-based anomaly detection logic 118 may be implemented at least in part in the form of software that is stored in memory and executed by a processor.

It is to be appreciated that the particular arrangement of the client devices 102, the IT infrastructure 105, the multimodal machine learning database 108 and the support platform 110 illustrated in the FIG. 1 embodiment is presented by way of example only, and alternative arrangements can be used in other embodiments. As discussed above, for example, the support platform 110 (or portions of components thereof, such as one or more of the multimodal machine learning-based security threat detection tool 112, the data modality-specific feature encoding logic 114, the scaling coefficient determination logic 116, and the multimodal machine learning-based anomaly detection logic 118) may in some embodiments be implemented internal to the IT infrastructure 105.

The support platform 110 and other portions of the information processing system 100, as will be described in further detail below, may be part of cloud infrastructure.

The support platform 110 and other components of the information processing system 100 in the FIG. 1 embodiment are assumed to be implemented using at least one processing platform comprising one or more processing devices each having a processor coupled to a memory. Such processing devices can illustratively include particular arrangements of compute, storage and network resources.

The client devices 102, IT infrastructure 105, the IT assets 106, the multimodal machine learning database 108 and the support platform 110 or components thereof (e.g., the multimodal machine learning-based security threat detection tool 112, the data modality-specific feature encoding logic 114, the scaling coefficient determination logic 116, and the multimodal machine learning-based anomaly detection logic 118) may be implemented on respective distinct processing platforms, although numerous other arrangements are possible. For example, in some embodiments at least portions of the support platform 110 and one or more of the client devices 102, the IT infrastructure 105, the IT assets 106 and/or the multimodal machine learning database 108 are implemented on the same processing platform. A given client device (e.g., 102-1) can therefore be implemented at least in part within at least one processing platform that implements at least a portion of the support platform 110.

The term “processing platform” as used herein is intended to be broadly construed so as to encompass, by way of illustration and without limitation, multiple sets of processing devices and associated storage systems that are configured to communicate over one or more networks. For example, distributed implementations of the information processing system 100 are possible, in which certain components of the system reside in one data center in a first geographic location while other components of the system reside in one or more other data centers in one or more other geographic locations that are potentially remote from the first geographic location. Thus, it is possible in some implementations of the information processing system 100 for the client devices 102, the IT infrastructure 105, IT assets 106, the multimodal machine learning database 108 and the support platform 110, or portions or components thereof, to reside in different data centers. Numerous other distributed implementations are possible. The support platform 110 can also be implemented in a distributed manner across multiple data centers.

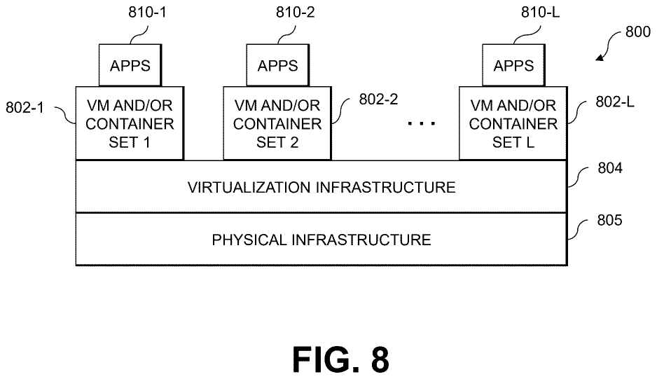

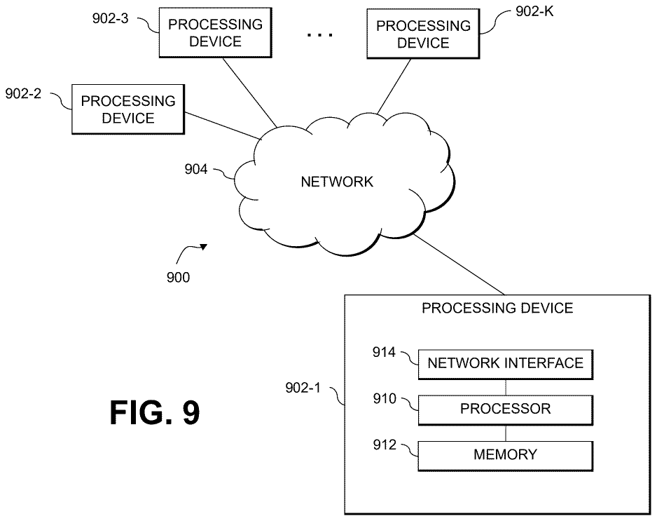

Additional examples of processing platforms utilized to implement the support platform 110 and other components of the information processing system 100 in illustrative embodiments will be described in more detail below in conjunction with FIGS. 8 and 9.

It is to be understood that the particular set of elements shown in FIG. 1 for multimodal machine learning-based anomaly detection is presented by way of illustrative example only, and in other embodiments additional or alternative elements may be used. Thus, another embodiment may include additional or alternative systems, devices and other network entities, as well as different arrangements of modules and other components.

It is to be appreciated that these and other features of illustrative embodiments are presented by way of example only, and should not be construed as limiting in any way.

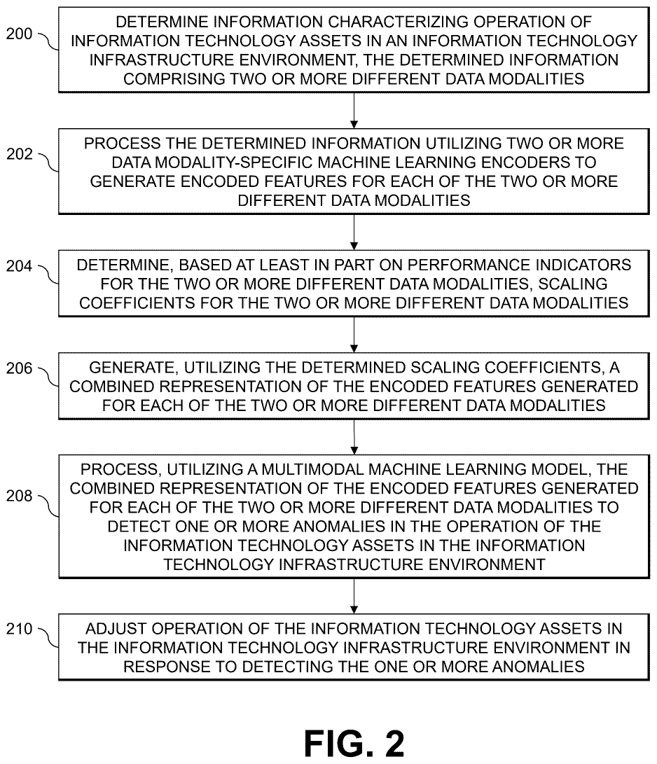

An exemplary process for multimodal machine learning-based anomaly detection will now be described in more detail with reference to the flow diagram of FIG. 2. It is to be understood that this particular process is only an example, and that additional or alternative processes for multimodal machine learning-based anomaly detection may be used in other embodiments.

In this embodiment, the process includes steps 200 through 210. These steps are assumed to be performed by the support platform 110 utilizing the multimodal machine learning-based security threat detection tool 112, the data modality-specific feature encoding logic 114, the scaling coefficient determination logic 116, and the multimodal machine learning-based anomaly detection logic 118. The process begins with step 200, determining information characterizing operation of IT assets in an IT infrastructure environment, the determined information comprising two or more different data modalities. The two or more different data modalities may comprise: a first data modality for network traffic logs characterizing network traffic associated with one or more of the IT assets in the IT infrastructure environment; a second data modality for system logs characterizing system alerts generated by one or more of the IT assets in the IT infrastructure environment; a third data modality for user behavior logs characterizing user behavior on one or more of the IT assets in the IT infrastructure environment; and/or a fourth data modality for application logs produced by one or more applications running on one or more of the IT assets in the IT infrastructure environment.

In step 202, the determined information is processed utilizing two or more data modality-specific machine learning encoders to generate encoded features for each of the two or more different data modalities.

Scaling coefficients for the two or more different data modalities are determined in step 204 based at least in part on performance indicators for the two or more different data modalities. Determining the scaling coefficients for the two or more different data modalities may be based at least in part on computing a dominance ratio characterizing whether a gradient of a given one of the two or more different data modalities is more than a threshold greater than one or more other ones of the two or more different data modalities. Computing the dominance ratio may comprise comparing at least one of average losses and confidence scores for the two or more different data modalities. If the gradient of the given data modality is more than the threshold greater than the one or more other ones of the two or more different data modalities, the scaling coefficient for the given data modality may be selected to dampen the gradient of the given data modality relative to the one or more other ones of the two or more different data modalities.

A combined representation of the encoded features for each of the two or more different data modalities is generated in step 206 utilizing the determined scaling coefficients. Generating the combined representation of the encoded features generated for each of the two or more different data modalities may comprise injecting stochastic noise in computation of gradients for the two or more different data modalities. The injected stochastic noise may comprise a Gaussian perturbation at least partially compensating for diminished gradient noise resulting from application of the determined scaling coefficients. Generating the combined representation of the encoded features generated for each of the two or more different data modalities may be based at least in part on determining temporal characteristics of the two or more different data modalities. Determining the temporal characteristics of the two or more different data modalities may comprise, for a given one of the two or more different data modalities: calculating local gradients for each of two or more time windows of data for the given data modality; and aggregating the local gradients across the two or more time windows to determine a final gradient for the given data modality. Aggregating the local gradients may comprise scaling the local gradients utilizing weighting coefficients characterizing relative significance of the two or more time windows.

In step 208, the combined representation of the encoded features generated for each of the two or more different data modalities is processed utilizing a multimodal machine learning model to detect one or more anomalies in the operation of the IT assets in the IT infrastructure environment. Operation of the IT assets in the IT infrastructure environment is modified in step 210 in response to detecting the one or more anomalies. Detecting the one or more anomalies may comprise detecting network security threats affecting the IT infrastructure environment. Adjusting operation of the IT assets in the IT infrastructure environment may comprise blocking network traffic associated with the detected network security threats.

The particular processing operations and other system functionality described in conjunction with the flow diagram of FIG. 2 are presented by way of illustrative example only, and should not be construed as limiting the scope of the disclosure in any way. Alternative embodiments can use other types of processing operations. For example, as indicated above, the ordering of the process steps may be varied in other embodiments, or certain steps may be performed at least in part concurrently with one another rather than serially. Also, one or more of the process steps may be repeated periodically, multiple instances of the process can be performed in parallel with one another, etc.

Functionality such as that described in conjunction with the flow diagram of FIG. 2 can be implemented at least in part in the form of one or more software programs stored in memory and executed by a processor of a processing device such as a computer or server. As will be described below, a memory or other storage device having executable program code of one or more software programs embodied therein is an example of what is more generally referred to herein as a “processor-readable storage medium.”

Multimodal machine learning may be utilized for generating machine learning models configured for threat detection (e.g., detection of network security threats for an IT infrastructure environment, such as an IT infrastructure environment that is operated or managed by an enterprise or other entity). Illustrative embodiments provide technical solutions for implementing an integrated multimodal machine learning framework configured to adaptively balance gradients from multiple data modalities and reinforce model generalization through controlled noise injection. The integrated multimodal machine learning framework is referred to herein as Artemis-GT (Adaptive Real-Time Equilibration with Injected Stochasticity for Gradient-Based Training). The Artemis-GT framework in some embodiments is specifically designed to handle multimodal data in complex network security threat detection. The Artemis-GT framework, however, may also be used for various other use cases involving multimodal machine learning.

The Artemis-GT framework addresses various technical challenges of conventional approaches, including the common imbalance problem where certain dominant modalities overshadow weaker ones during training, leading to sub-optimal performance. To overcome these and other technical challenges, the Artemis-GT framework employs a real-time gradient modulation procedure that adaptively scales gradient updates for each modality based on a continuously monitored dominance ratio. This rebalancing ensures that lower-performing modalities receive sufficient optimization focus without being suppressed by stronger counterparts. Additionally, the Artemis-GT framework in some embodiments incorporates a stochastic augmentation mechanism that injects controlled noise into the training process, preserving or enhancing gradient variability which is critical for generalization.

Beyond the fundamental balancing paradigm, the Artemis-GT framework in some embodiments implements a novel Temporal Gradient Decomposition (TGD) component to reinforce the modeling of temporal or sequence-based information. The TGD component integrates seamlessly with the overarching Artemis-GT framework, enabling stronger detection of anomalies characterized by temporal patterns (e.g., in network logs, system alerts, user behavior data, etc.). Empirical indicators show improved generalization and robustness across various domains, making it a compelling approach for safeguarding IT infrastructure environments (e.g., enterprise computing networks) against evolving threats.

Multimodal machine learning is able to integrate diverse data sources, such as network logs, user behaviors and system events, to enhance anomaly detection and cybersecurity. Conventional approaches for multimodal machine learning, however, have various technical challenges including technical challenges related to handling gradient dominance, stochastic noise and temporal dependencies.

Multimodal machine learning frameworks may be configured to dynamically adjust gradient contributions to mitigate modality imbalances. While effective in rebalancing gradients for dominant modalities, conventional approaches for implementing multimodal machine learning frameworks do not incorporate stochastic augmentation, which is crucial for preventing overfitting and ensuring generalization in dynamic scenarios. In some approaches, security vulnerabilities of multimodal systems may be at least partially addressed by examining gradient-based backdoor attacks. While highlighting the risk of adversarial inputs, such approaches primarily focus on attack defense rather than improving optimization under imbalanced modality conditions. A Certifiable Robust Multimodal Training (CRMT) framework may enhance robustness to temporal anomalies. Although CRMT integrates robustness mechanisms, it lacks the ability to dynamically adapt to real-time modality imbalances or preserve stochasticity, both of which are essential for long-term generalization. An Adaptive Gradient Modulation (AGM) strategy may be used to adjust gradient contributions dynamically during multimodal training. AGM, however, fails to address temporal dependencies in multimodal data or inject stochastic noise into the training process, leading to potential overfitting. Modality-specific optimization techniques may be used for specific use cases, such as for biometric fusion. While such techniques enhance individual modality performance, such techniques struggle with generalization across evolving or heterogeneous datasets, which present a significant challenge in various use cases including threat detection in enterprise network security environments.

Multimodal machine learning frameworks, despite advancements, are subject to various technical challenges including: the absence of temporal gradient modeling which limits the ability to detect anomalies in sequential data, which is critical for cybersecurity applications; excessive gradient suppression in many frameworks which leads to overfitting by reducing gradient variability, a key factor for generalization; and the reliance on static of fixed gradient balancing mechanisms which make them ill-suited for real-time multimodal learning in dynamic enterprise environments. To address these and other technical challenges, the technical solutions described herein provide the Artemis-GT framework which is able: to enforce dynamic and adaptive gradient balancing among diverse data modalities; to preserve or enhance stochastic gradient noise for robust generalization; and to seamlessly incorporate additional components for modeling temporal relationships essential in real-world security scenarios.

The Artemis-GT framework provides a dynamic and integrated approach to multimodal training. Unlike conventional approaches, the Artemis-GT framework incorporates functionality for real-time gradient modulation based on a continuously monitored dominance ratio, ensuring adaptive balancing across modalities. To enhance generalization, the Artemis-GT framework adds a controlled stochastic noise component to the optimization process, mitigating the overfitting issues common in conventional approaches. Moreover, the Artemis-GT framework incorporates the TGD module to explicitly model temporal dependencies by partitioning data into time windows and aggregating local gradients, allowing for improved anomaly detection in sequential data. These and other innovations make the Artemis-GT framework a robust and flexible framework for network security and other applications, offering a comprehensive solution for addressing technical challenges of conventional approaches such as multimodal data imbalance, generalization and temporal modeling.

In some embodiments, the Artemis-GT multimodal training framework integrates adaptive gradient realignment, stochastic augmentation and TGD. Adaptive gradient realignment provides a mechanism for calculating a dominance ratio for each modality in real-time. When one modality exhibits consistently larger gradients, its updates are scaled down, permitting weaker modalities to catch up. This solution ensures continuous equilibrium among all modalities without requiring separate training phases or external teacher networks. Stochastic augmentation enables maintenance of essential gradient noise levels that drive better generalization. The Artemis-GT framework injects a controlled Gaussian component back into the update step. By fine-tuning the strength of this noise, the system avoids the pitfalls of gradient “over-suppression,” thus mitigating overfitting and promoting broader coverage of the feature space. TGD processes multimodal input sequences for time-based anomaly detection scenarios. TGD decomposes gradients over sequential windows or segments, enabling the Artemis-GT framework to capture evolving threats and irregularities in different data modalities (e.g., network logs, system events, user behaviors, etc.). Together, these functionalities form a unified, computationally tractable framework suited to a variety of industrial contexts and use cases, including large-scale enterprise security monitoring. By aligning gradient magnitudes across modalities in real-time and preserving generalization, the Artemis-GT framework achieves enhanced accuracy and robustness under the heterogeneous conditions typical of network threat detection.

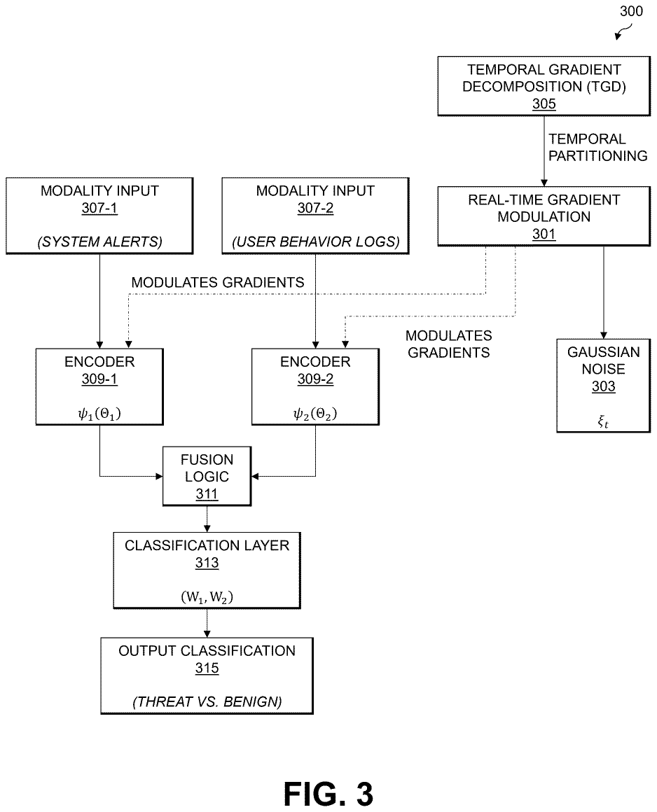

FIG. 3 shows a system 300 implementing the Artemis-GT framework, which utilizes multiple synergistic components including real-time gradient modulation 301, stochastic noise injection via Gaussian noise component 303 (ξₜ) and TGD 305. The system 300 illustrates the high-level architecture of the Artemis-GT framework, and depicts the flow of multimodal data through the Artemis-GT framework. The system 300 includes separate encoders 309-1 and 309-2 (collectively, encoders 309) for different modality inputs 307-1 and 307-2 (collectively, modality inputs 307), fusion logic 311, and a classification layer 313 which generates output classification 315 (e.g., whether a particular sample is a network security threat or benign). The real-time gradient modulation 301 and stochastic noise injection via Gaussian noise component 303 enhance training by dynamically adjusting gradients and injecting noise. The TGD 305 processes sequential data, enabling fine-grained optimization.

Let the multimodal training set be:

$$𝒮 = {\{ ( {X}_{i}^{( 1 )} , {X}_{i}^{( 2 )} ) , {Y}_{i} \}}_{i = 1}^{N}$$

where

$$( {X}_{i}^{( 1 )} , {X}_{i}^{( 2 )} )$$

denote two different modalities (e.g., system alerts and user behavior logs in network security), and Yᵢ is the label or classification output (e.g., “threat” or “benign”). It should be noted that more than two different modalities may be used, and that embodiments are not limited to use with only two modalities. Each modality m∈{1, 2} has its own encoder ψₘ(Θₘ, X^{(m)}). The resulting encoded features are combined via a lightweight fusion mechanism (e.g., concatenation) and passed to a classification layer W. Formally:

$$F ( {X}_{i}^{( 1 )} , {X}_{i}^{( 2 )} ) = {W}_{1} {ψ}_{1} ( {Θ}_{1} , {X}_{i}^{( 1 )} ) + {W}_{2} {ψ}_{2} ( {Θ}_{2} , {X}_{i}^{( 2 )} )$$

The system is trained with a loss function [symbol] (e.g., cross-entropy), and standard stochastic gradient descent (SGD) updates θ₁, θ₂, W₁, W₂.

Real-time gradient modulation involves a dominance ratio

$$( {ρ}_{t}^{m} ) ,$$

a scaling coefficient

$$( {γ}_{t}^{m} )$$

and an updated SGD rule. The dominance ratio

$${ρ}_{t}^{m}$$

measures the relative dominance of modality m at training iteration t. This may be computed by comparing average losses or confidence scores of each modality:

$${ρ}_{t}^{m} = \frac{performance indicator of modality m}{performance indicator of the other modality}$$

### If

$${ρ}_{t}^{m} > 1 ,$$

modality m is considered dominant at step t.

The scaling coefficient

$${γ}_{t}^{m}$$

is defined to rescale the gradient updates for modality m. In some embodiments,

$${γ}_{t}^{m}$$

is determined according to:

$${γ}_{t}^{m} = \{ \begin{matrix}1 - tanh ( α {ρ}_{t}^{m} ) & if {ρ}_{t}^{m} > 1 , \\ 1 , & otherwise .\end{matrix}$$

Here, α is a hyperparameter tuning how aggressively to dampen the dominant modality's gradient.

For modality m, the partial gradient estimate at iteration t is denoted ĝ(Θₘ). The standard SGD update,

$${Θ}_{m , t + 1} = {Θ}_{m , t} - η \hat{g} ( {Θ}_{m , t} ) ,$$

$$becomes$$

$${Θ}_{m , t + 1} = {Θ}_{m , t} - η {γ}_{t}^{m} \hat{g} ( {Θ}_{m , t} ) ,$$

effectively scaling down the updates if modality m has exceeded a specified dominance threshold.

Stochastic noise injection is used to compensate for the diminished gradient noise when

$${γ}_{t}^{m} < 1 .$$

Thus, the Artemis-GT framework adds a Gaussian perturbation ξₜ to each update:

$${Θ}_{m , t + 1} = {Θ}_{m , t} - η {γ}_{t}^{m} \hat{g} ( {Θ}_{m , t} ) + {ξ}_{t} )$$

This controlled noise injection ensures that the training process retains sufficient stochasticity to generalize effectively, even when certain modalities are frequently dampened.

To handle data modalities with intrinsic temporal or sequential characteristics (e.g., evolving patterns in network traffic logs, time-ordered system events, user action histories, etc.), the Artemis-GT framework implements TGD. TGD includes time-window partitioning, local gradient aggregation, and integration with real-time modulation. Time-window partitioning includes partitioning the sequence of data inputs (for each modality m) into discrete time windows: {W₁, W₂, . . . , W_{K}}. Each window captures a slice of the temporal progression (e.g., short bursts of system alerts or user actions). For example, time window W₁ may be associated with a time window between times to and t₁, time window W₂ may be associated with a time window between times t₁ and t₂, time window W₃ may be associated with a time window between times t₂ and t₃, etc.

Local gradient aggregation includes computing local gradients ĝₖ(Θₘ) within each time window Wₖ. Instead of a single global gradient, TGD aggregates local gradients for the time windows with a temporal weighting function βₖ, capturing the significance of each time window:

$${\tilde{g}}_{k} ( {Θ}_{m} ) = {\sum }_{k = 1}^{K} {β}_{k} {\hat{g}}_{k} ( {Θ}_{m} )$$

Integration with real-time modulation includes subjecting the local aggregated gradient \tilde{g}(Θₘ) to the same real-time modulation:

$${Θ}_{m , t + 1} = {Θ}_{m , t} - η {γ}_{t}^{m} \hat{( g} ( {Θ}_{m , t} ) + {ξ}_{t} )$$

By focusing on time-segmented gradients, TGD bolsters the detection of anomalies that might only manifest during specific temporal intervals.

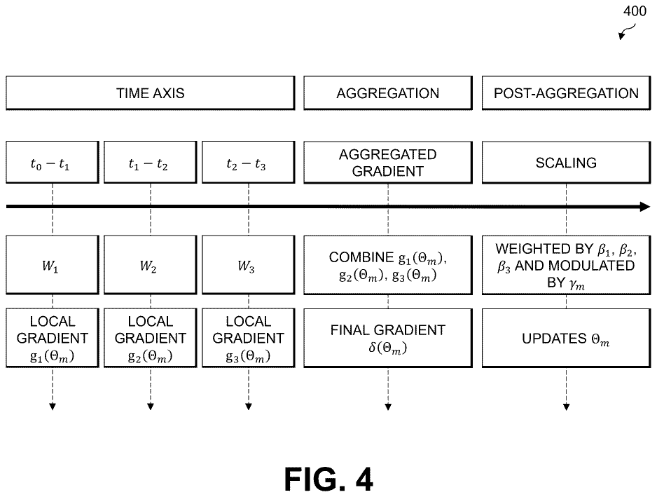

FIG. 4 illustrates a TGD structure 400, illustrating how TGD partitions sequential data into overlapping time windows (W₁, W₂, W₃), calculates local gradients for each window (g₁(Θₘ), g₂(Θₘ), g₃(Θₘ)), and then aggregates these local gradients into a single combined or final gradient δ(Θₘ). The aggregated gradient is scaled by weighting coefficients (β₁, β₂, β₃) modulated by the Artemis-GT framework's real-time gradient modulation (γₘ), ensuring dynamic and adaptive updates for parameter optimization. This process enables fine-grained handling of temporal information in sequential data.

Collectively, the real-time gradient modulation, stochastic noise injection and TGD enable the Artemis-GT framework to offer a robust, lightweight and flexible framework for multimodal machine learning-based threat detection. The Artemis-GT framework is advantageously able to adaptively balance gradient contributions for multiple data modalities in real-time by scaling gradient updates according to a learned dominance ratio. The Artemis-GT framework also advantageously introduces stochastic noise injection into each parameter update, ensuring sufficient gradient variance to preserve or enhance generalization even under aggressive gradient modulation. The Artemis-GT framework further advantageously provides a TGD component that partitions sequential data into time windows, aggregates local gradients and integrates with the adaptive modulation for improved detection of temporally distributed threats in network security.

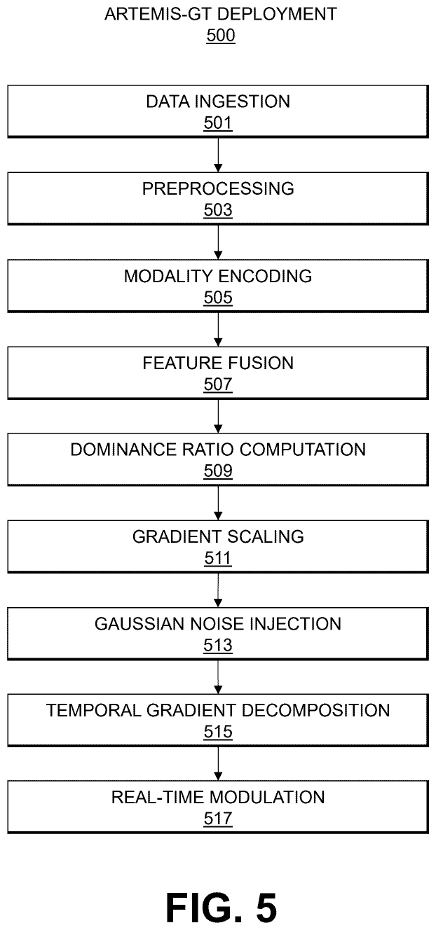

FIG. 5 shows a process flow 500 for deploying the Artemis-GT framework in an enterprise security pipeline (e.g., within an IT infrastructure monitoring or asset management system, a support platform, etc.). The process flow 500 begins with data ingestion in block 501, where raw multimodal data (e.g., network traffic records, system alerts, user behavior logs, etc.) are ingested. In block 503, the ingested data is preprocessed into standardized feature representations. In block 505, each modality is then passed through its own encoder (e.g., a 1D Convolutional Neural Network (CNN) for packet-level data, a Recurrent Neural Network (RNN) or Transformer for sequential alerts, etc.) to produce encoded features. The encoded features are fused into a single representation for classification in block 507. In block 509, during each training iteration, a dominance ratio is computed to assess if one modality's gradient excessively dominates. If so, a scaling coefficient dampens that modality's gradient through gradient scaling in block 511 while injecting controlled Gaussian noise in block 513. This ensures that no single source overshadows the others, while preserving useful gradient stochasticity for better generalization. In block 515, TGD is applied to capture time-sequenced anomalies often overlooked by purely static models. The sequential data from each modality is partitioned into time windows, and local gradients from each segment are aggregated with learned or preset temporal weights before entering real-time gradient modulation in block 517. The TGD ensures that the model remains sensitive to evolving threats across discrete time intervals, which is critical for detecting stealthy or long-duration attacks in enterprise networks. By combining adaptive gradient balancing, noise injection and TGD, the Artemis-GT framework is advantageously able to achieve robust threat detection suited for continuous monitoring scenarios.

The Artemis-GT framework is evaluated utilizing a sample dataset with network traffic and log information that simulates various attack scenarios. To evaluate the feasibility and potential of the Artemis-GT framework and validate whether the adaptive balancing and TGD functionality align with theoretical advantages (e.g., improved generalization and modality balancing), several variants are compared. The variants include: a baseline or standard multimodal training with two encoders (e.g., for system logs and network traffic) fused by concatenation, with no modulation and no noise injection; the Artemis-GT framework without TGD functionality, which includes real-time gradient modulation and noise injection but excludes time window decomposition; the full Artemis-GT framework with TGD functionality, incorporating time window partitioning and local gradient aggregation; and an attention-based multimodal approach. Various evaluation metrics are used, including: accuracy (Acc), F1 score (F1) and False Negative Rate (FNR). Acc is computed according to

$$\frac{\# correct predictions}{\# total samples} ,$$

measuring the overall classification correctness. F1 is computed according to

$$\frac{Prec i s ion \times Recall}{Prec ision + Recall} ,$$

balancing precision and recall. The FNR is computed according to

$$\frac{\# missed attacks}{\# total attacks} ,$$

measuring the fraction of true attacks that go undetected.

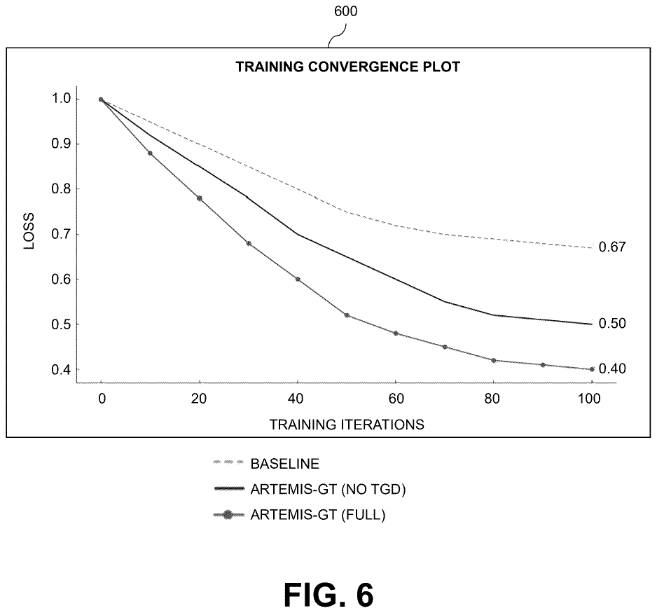

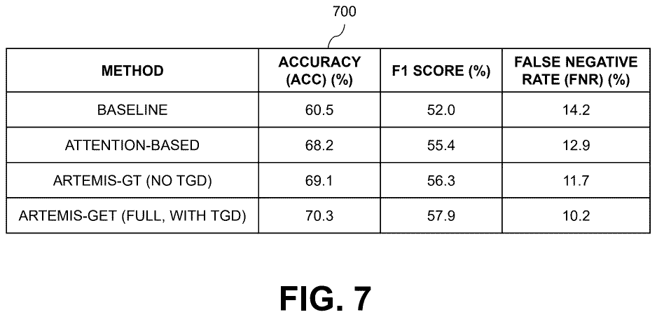

FIG. 6 shows a training convergence plot 600, illustrating the convergence of training loss across iterations for the baseline, Artemis-GT without TGD, and full Artemis-GT with TGD approaches. The training convergence plot 600 highlights that the full Artemis-GT with TGD approach achieves faster and smoother convergence, due to its advanced gradient modulation and noise injection mechanisms. This demonstrates its effectiveness in training stability and efficiency. FIG. 7 shows a table 700 of evaluation metrics (Acc, F1, FNR) for the different approaches. The results shown in table 700 indicate that the full Artemis-GT with TGD approach yields a notable improvement in both accuracy and F1 score, while reducing missed attacks (FNR). These gains are attributed to the combined benefits of adaptive gradient realignment, controlled noise injection, and explicit modeling of temporal windows. Although the results are not maximized due to limited hyperparameter tuning and partial optimization, the positive trend validates the theoretical underpinnings.

While various embodiments are described above with respect to the use of two different modalities (e.g., system alerts and user behavior logs), the technical solutions described herein can integrate various other modalities into the Artemis-GT framework for real-world enterprise IT infrastructure environments. For example, extended user behavior logs, device-specific system alerts and custom application logs may be used as additional modalities. The TGD module may be adapted to domain-specific time window definitions (e.g., session-based windows or shift-based intervals). The performance gains achieved using the Artemis-GT framework may be further realized through fully tailoring the Artemis-GT framework to the internal data and production environment in which it is used.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

Illustrative embodiments of processing platforms utilized to implement functionality for multimodal machine learning-based anomaly detection will now be described in greater detail with reference to FIGS. 8 and 9. Although described in the context of system 100, these platforms may also be used to implement at least portions of other information processing systems in other embodiments.

FIG. 8 shows an example processing platform comprising cloud infrastructure 800. The cloud infrastructure 800 comprises a combination of physical and virtual processing resources that may be utilized to implement at least a portion of the information processing system 100 in FIG. 1. The cloud infrastructure 800 comprises multiple virtual machines (VMs) and/or container sets 802-1, 802-2, . . . 802-L implemented using virtualization infrastructure 804. The virtualization infrastructure 804 runs on physical infrastructure 805, and illustratively comprises one or more hypervisors and/or operating system level virtualization infrastructure. The operating system level virtualization infrastructure illustratively comprises kernel control groups of a Linux operating system or other type of operating system.

The cloud infrastructure 800 further comprises sets of applications 810-1, 810-2, . . . 810-L running on respective ones of the VMs/container sets 802-1, 802-2, . . . 802-L under the control of the virtualization infrastructure 804. The VMs/container sets 802 may comprise respective VMs, respective sets of one or more containers, or respective sets of one or more containers running in VMs.

In some implementations of the FIG. 8 embodiment, the VMs/container sets 802 comprise respective VMs implemented using virtualization infrastructure 804 that comprises at least one hypervisor. A hypervisor platform may be used to implement a hypervisor within the virtualization infrastructure 804, where the hypervisor platform has an associated virtual infrastructure management system. The underlying physical machines may comprise one or more distributed processing platforms that include one or more storage systems.

In other implementations of the FIG. 8 embodiment, the VMs/container sets 802 comprise respective containers implemented using virtualization infrastructure 804 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element may be viewed as an example of what is more generally referred to herein as a “processing device.” The cloud infrastructure 800 shown in FIG. 8 may represent at least a portion of one processing platform. Another example of such a processing platform is processing platform 900 shown in FIG. 9.

The processing platform 900 in this embodiment comprises a portion of system 100 and includes a plurality of processing devices, denoted 902-1, 902-2, 902-3, . . . 902-K, which communicate with one another over a network 904.

The network 904 may comprise any type of network, including by way of example a global computer network such as the Internet, a WAN, a LAN, a satellite network, a telephone or cable network, a cellular network, a wireless network such as a WiFi or WiMAX network, or various portions or combinations of these and other types of networks.

The processing device 902-1 in the processing platform 900 comprises a processor 910 coupled to a memory 912.

The processor 910 may comprise a microprocessor, a microcontroller, an application-specific integrated circuit (ASIC), a field-programmable gate array (FPGA), a central processing unit (CPU), a graphics processing unit (GPU), a tensor processing unit (TPU), a video processing unit (VPU), a neural processing unit (NPU), a data processing unit (DPU), a System-On-Chip (SOC) or other type of processing circuitry, as well as portions or combinations of such circuitry elements.

The memory 912 may comprise random access memory (RAM), read-only memory (ROM), flash memory or other types of memory, in any combination. The memory 912 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM, flash memory or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 902-1 is network interface circuitry 914, which is used to interface the processing device with the network 904 and other system components, and may comprise conventional transceivers.

The other processing devices 902 of the processing platform 900 are assumed to be configured in a manner similar to that shown for processing device 902-1 in the figure.

Again, the particular processing platform 900 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

As indicated previously, components of an information processing system as disclosed herein can be implemented at least in part in the form of one or more software programs stored in memory and executed by a processor of a processing device. For example, at least portions of the functionality for multimodal machine learning-based anomaly detection as disclosed herein are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems, IT assets, etc. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. An apparatus comprising:
at least one processing device comprising a processor coupled to a memory;
the at least one processing device being configured:
to determine information characterizing operation of information technology assets in an information technology infrastructure environment, the determined information comprising two or more different data modalities;
to process the determined information utilizing two or more data modality-specific machine learning encoders to generate encoded features for each of the two or more different data modalities;
to determine, based at least in part on performance indicators for the two or more different data modalities, scaling coefficients for the two or more different data modalities;
to generate, utilizing the determined scaling coefficients, a combined representation of the encoded features generated for each of the two or more different data modalities;
to process, utilizing a multimodal machine learning model, the combined representation of the encoded features generated for each of the two or more different data modalities to detect one or more anomalies in the operation of the information technology assets in the information technology infrastructure environment; and
to modify operation of the information technology assets in the information technology infrastructure environment in response to detecting the one or more anomalies.

2. The apparatus of claim 1 wherein the two or more different data modalities comprise:
a first data modality for network traffic logs characterizing network traffic associated with one or more of the information technology assets in the information technology infrastructure environment;
a second data modality for system logs characterizing system alerts generated by one or more of the information technology assets in the information technology infrastructure environment.

3. The apparatus of claim 2 wherein the two or more different data modalities further comprise at least a third data modality for user behavior logs characterizing user behavior on one or more of the information technology assets in the information technology infrastructure environment.

4. The apparatus of claim 2 wherein the two or more different data modalities further comprise at least a third data modality for application logs produced by one or more applications running on one or more of the information technology assets in the information technology infrastructure environment.

5. The apparatus of claim 1 wherein determining the scaling coefficients for the two or more different data modalities is based at least in part on computing a dominance ratio characterizing whether a gradient of a given one of the two or more different data modalities is more than a threshold greater than one or more other ones of the two or more different data modalities.

6. The apparatus of claim 5 wherein computing the dominance ratio comprises comparing at least one of average losses and confidence scores for the two or more different data modalities.

7. The apparatus of claim 5 wherein, if the gradient of the given data modality is more than the threshold greater than the one or more other ones of the two or more different data modalities, the scaling coefficient for the given data modality is selected to dampen the gradient of the given data modality relative to the one or more other ones of the two or more different data modalities.

8. The apparatus of claim 1 wherein generating the combined representation of the encoded features generated for each of the two or more different data modalities comprises injecting stochastic noise in computation of gradients for the two or more different data modalities.

9. The apparatus of claim 8 wherein the injected stochastic noise comprises a Gaussian perturbation at least partially compensating for diminished gradient noise resulting from application of the determined scaling coefficients.

10. The apparatus of claim 1 wherein generating the combined representation of the encoded features generated for each of the two or more different data modalities is based at least in part on determining temporal characteristics of the two or more different data modalities.

11. The apparatus of claim 10 wherein determining the temporal characteristics of the two or more different data modalities comprises, for a given one of the two or more different data modalities:
calculating local gradients for each of two or more time windows of data for the given data modality; and
aggregating the local gradients across the two or more time windows to determine a final gradient for the given data modality.

12. The apparatus of claim 11 wherein aggregating the local gradients comprises scaling the local gradients utilizing weighting coefficients characterizing relative significance of the two or more time windows.

13. The apparatus of claim 1 wherein detecting the one or more anomalies comprises detecting network security threats affecting the information technology infrastructure environment.

14. The apparatus of claim 13 wherein modifying operation of the information technology assets in the information technology infrastructure environment comprises blocking network traffic associated with the detected network security threats.

15. A computer program product comprising a non-transitory processor-readable storage medium having stored therein program code of one or more software programs, wherein the program code when executed by at least one processing device causes the at least one processing device:
to determine information characterizing operation of information technology assets in an information technology infrastructure environment, the determined information comprising two or more different data modalities;
to process the determined information utilizing two or more data modality-specific machine learning encoders to generate encoded features for each of the two or more different data modalities;
to determine, based at least in part on performance indicators for the two or more different data modalities, scaling coefficients for the two or more different data modalities;
to generate, utilizing the determined scaling coefficients, a combined representation of the encoded features generated for each of the two or more different data modalities;
to process, utilizing a multimodal machine learning model, the combined representation of the encoded features generated for each of the two or more different data modalities to detect one or more anomalies in the operation of the information technology assets in the information technology infrastructure environment; and
to modify operation of the information technology assets in the information technology infrastructure environment in response to detecting the one or more anomalies.

16. The computer program product of claim 15 wherein determining the scaling coefficients for the two or more different data modalities is based at least in part on computing a dominance ratio characterizing whether a gradient of a given one of the two or more different data modalities is more than a threshold greater than one or more other ones of the two or more different data modalities.

17. The computer program product of claim 15 generating the combined representation of the encoded features generated for each of the two or more different data modalities is based at least in part on determining temporal characteristics of the two or more different data modalities.

18. A method comprising:
determining information characterizing operation of information technology assets in an information technology infrastructure environment, the determined information comprising two or more different data modalities;
processing the determined information utilizing two or more data modality-specific machine learning encoders to generate encoded features for each of the two or more different data modalities;
determining, based at least in part on performance indicators for the two or more different data modalities, scaling coefficients for the two or more different data modalities;
generating, utilizing the determined scaling coefficients, a combined representation of the encoded features generated for each of the two or more different data modalities;
processing, utilizing a multimodal machine learning model, the combined representation of the encoded features generated for each of the two or more different data modalities to detect one or more anomalies in the operation of the information technology assets in the information technology infrastructure environment; and
modifying operation of the information technology assets in the information technology infrastructure environment in response to detecting the one or more anomalies
wherein the method is performed by at least one processing device comprising a processor coupled to a memory.

19. The method of claim 18 wherein determining the scaling coefficients for the two or more different data modalities is based at least in part on computing a dominance ratio characterizing whether a gradient of a given one of the two or more different data modalities is more than a threshold greater than one or more other ones of the two or more different data modalities.

20. The method of claim 18 generating the combined representation of the encoded features generated for each of the two or more different data modalities is based at least in part on determining temporal characteristics of the two or more different data modalities.
